(19) United States
(12) Patent Application Publication
(10) Pub. No.: US 2012/0107657 A1
(43) Pub. Date: May 3, 2012

(54) CABLE-TYPE SECONDARY BATTERY

(76) Inventors: Yo-Han KWON, Daejeon (KR); Je-Young KIM, Daejeon (KR)

(21) Appl. No.: 13/339,620

(22) Filed: Dec. 29, 2011

Related U.S. Application Data
(63) Continuation of application No. PCT/KR2011/004144, filed on Jun. 7, 2011.

(30) Foreign Application Priority Data
Oct. 26, 2010 (KR) 10-2010-0104644

(51) Int. Cl. H01M 4/02

(52) U.S. Cl. 429/94

(57) ABSTRACT

Provided is a cable-type secondary battery including an electrode assembly and a cover member surrounding the electrode assembly, the electrode assembly including first and second electrodes of an elongated shape and a separator or an electrolyte layer interposed between the first and second electrodes, each electrode including a current collector having a cross section of a circular, asymmetrical oval or polygonal shape perpendicular to the lengthwise direction thereof and an electrode active material applied onto the surface of the current collector, wherein the cover member has a preset pattern of continuous or discontinuous scratch grooves on the surface thereof.

The cable-type secondary battery protects and/or coats the electrode assembly using the improved cover member having the scratch grooves, thereby improving the flexibility of the cable-type secondary battery.

### CROSS-REFERENCE TO RELATED APPLICATION(S)

This application is a continuation of International Application PCT/KR2011/004144 filed on Jun. 7, 2011, which claims priority from Korean Patent Application No. 10-2010-0104644 filed in the Republic of Korea on Oct. 26, 2010, the entire contents of which are incorporated herein by reference.

### BACKGROUND

1. Technical Field

The present invention relates to a cable-type secondary battery of free shape adaptation, and more particularly, to a cable-type secondary battery having an improved structure of a coating (cover member) surrounding a cable-type electrode assembly.

2. Background Art

Recently, advances in wireless communication technologies have led to the popularization of mobile devices, and to keep pace with this trend, there is a strong tendency to use secondary batteries as a power source of mobile devices. Secondary batteries are also used as a power source of environmentally friendly next-generation vehicles such as electric vehicles and hybrid vehicles.

As described above, as the use of secondary batteries is dramatically increasing in many fields of industry, secondary batteries are varying in output, capacity, structure, and the like, depending on the characteristics of the field where the secondary batteries are used.

Generally, a secondary battery is provided with an electrode assembly including a cathode and an anode, each having a plate-like current collector surface-coated with an active material, and a separator interposed between the cathode and the anode. The electrode assembly is received in a cylindrical or prismatic metal casing or a pouch-type casing of an aluminum laminate sheet, together with a liquid electrolyte or a solid electrolyte. To improve the capacity of the secondary battery, the electrode assembly may be a jelly-roll type in which a cathode sheet, a separator sheet, and an anode sheet are rolled together, or a stack-type in which a plurality of unit electrodes of a thin plate shape are sequentially stacked. Accordingly, the electrode (cathode and anode) of the electrode assembly has a substantially plate-like structure.

The conventional plate-like electrode structure is advantageous in that it has a high degree of integration when rolling or stacking, but has difficulty in adaptively changing the structure to meet the demand of the industrial field. Furthermore, the plate-like electrode structure has various problems in that it is sensitive to the change in volume of the electrode during charging/discharging, the gas generated in the cell may not easily discharge, and the potential difference between the electrodes may increase.

Particularly, to meet the various needs of the users, the kinds of devices using secondary batteries are diversifying and a lot of emphasis is put on designing such devices. However, devices having a special shape need to offer a separate portion or space for mounting secondary batteries having a traditional structure and/or shape (cylindrical, prismatic, or pouch-type), which becomes a great obstacle when expanding the wireless technologies and developing new designs. For example, when a newly developed device has an elongated space for mounting a secondary battery, it is substantially impossible or very inefficient to structurally change the secondary battery including an electrode assembly made up of existing plate-like electrodes to suit the structure to the mounting space. In other words, since the conventional cylindrical, coin-type, and prismatic batteries have specific shapes, the batteries are limited in its use and ability to freely deform. Also, it is difficult to adaptively deform, for example, twist or bend, depending on where the batteries are used.

To solve these problems, the inventors have disclosed Korean Patent No. 10-0804411 (filed Jan. 17, 2006, registered Feb. 12, 2008) titled “electrode assembly of novel structure and secondary battery comprising the same”.

However, this secondary battery (hereinafter referred to as a cable-type secondary battery) still has insufficient flexibility.

### DISCLOSURE

### Technical Problem

To solve the above problems, it is an object of the present invention to provide a secondary battery of an improved structure that is easily adaptable in shape to maintain stability and excellent performance.

### Technical Solution

A cable-type secondary battery of the present invention may include an electrode assembly and a cover member surrounding the electrode assembly, the electrode assembly including first and second electrodes of an elongated shape and a separator or an electrolyte layer interposed between the first and second electrodes, each electrode including a current collector having a cross section of a circular, asymmetrical oval or polygonal shape perpendicular to the lengthwise direction thereof and an electrode active material applied onto the surface of the current collector, wherein the cover member has a preset pattern of scratch grooves on the surface thereof.

Preferably, the scratch grooves have a depth of 10 to 30% to a thickness of the cover member.

The scratch grooves may have a linear pattern having a predetermined angle to the lengthwise direction of the cover member, or may also have a wavy pattern having a predetermined angle to the lengthwise direction of the cover member.

Also, the scratch grooves may have a grid pattern, and the scratch grooves may include a plurality of irregular grooves.

In this instance, the first and second electrodes of opposite polarity may each be an anode or a cathode. Preferably, the first electrode may be an anode, and the second electrode may be a cathode.

Preferably, the current collector is made from stainless steel, aluminum, nickel, titanium, sintered carbon, or copper; stainless steel surface-treated with carbon, nickel, titanium, or silver; aluminum-cadmium alloys; non-conductive polymer surface-treated with a conductive material; or conductive polymers. The conductive material may be polyacetylene, polyaniline, polypyrrole, polythiophene, polysulfur nitride, indium thin oxide (ITO), copper, silver, palladium, or nickel. The conductive polymer may be polyacetylene, polyaniline, polypyrrole, polythiophene, or polysulfur nitride. The anode active material may be natural graphite, artificial graphite, or carbonaceous materials; lithium-containing titanium composite oxides (LTOs); metals (Me) such as Si, Sn, Li, Zn, Mg, Cd, Ce, Ni, or Fe; alloys of the metals (Me); oxides (MeOx) of the metals (Me); or composites of the metals (Me) and carbon. The cathode active material may be any one selected from the group consisting of LiCoO₂, LiNiO₂, LiMn₂O₄, LiCoPO₄, LiFePO₄, LiNiMnCoO₂, and LiNi_{1-x-y-z}CoₓM1_{y}M2_{z}O₂ (M1 and M2 are each independently any one selected from the group consisting of Al, Ni, Co, Fe, Mn, V, Cr, Ti, W, Ta, Mg, and Mo, and x, y, and z are each independently an atomic fraction of each component in the oxide, where 0≦x<0.5, 0≦y<0.5, 0≦z<0.5, x+y+z≦1).

The electrolyte layer may be formed from a gel polymer electrolyte of PEO, PVdF, PMMA, PAN, or PVAc; or a solid polymer electrolyte of PEO, polypropylene oxide (PPO), polyethylene imine (PEI), polyethyl sulphide (PES), or PVAc.

In the cable-type secondary battery of the present invention, the electrolyte layer may further include a lithium salt. The lithium salt may be LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chlorine borane lithium, aliphatic lower lithium carbonate, or tetra-phenyl lithium borate.

The separator may be any one selected from the group consisting of a microporous polyethylene film, a microporous polypropylene film, or a multi-layered film of these films, and a polymer film for a polymer electrolyte of polyvinylidene fluoride, polyethylene oxide, polyacrylonitrile, or polyvinylidene fluoride-hexafluoropropylene copolymer.

### Advantageous Effect

The cable-type secondary battery of the present invention protects or coats the electrode assembly using the improved cover member having the scratch grooves, thereby improving the flexibility of the cable-type secondary battery.

### DESCRIPTION OF DRAWINGS

The accompanying drawings illustrate preferred embodiments of the present disclosure and, together with the foregoing disclosure, serve to provide further understanding of the technical spirit of the present disclosure. However, the present disclosure is not to be construed as being limited to the drawings.

FIG. 1 is a perspective view of a cable-type secondary battery according to an embodiment of the present invention.

FIG. 2 is a side elevation view of a cable-type secondary battery with a linear pattern of scratch grooves perpendicular to the lengthwise direction of a cover member according to an embodiment of the present invention.

FIG. 3 is a side elevation view of a cable-type secondary battery with a linear pattern of scratch grooves inclined to the lengthwise direction of a cover member according to an embodiment of the present invention.

FIG. 4 is a side elevation view of a cable-type secondary battery with a wavy pattern of scratch grooves having a predetermined angle to the lengthwise direction of a cover member according to an embodiment of the present invention.

FIG. 5 is a side elevation view of a cable-type secondary battery with a grid pattern of scratch grooves according to an embodiment of the present invention.

FIG. 6 is a side elevation view of a cable-type secondary battery with a plurality of irregular scratch grooves according to an embodiment of the present invention.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

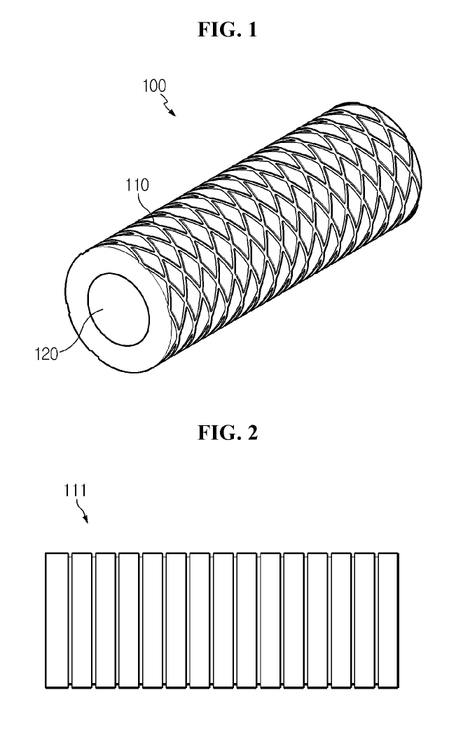

A cable-type secondary battery according to an embodiment of the present invention is schematically illustrated in FIG. 1. Although a few exemplary embodiments of the present invention are shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

Referring to FIG. 1, a cable-type secondary battery 100 according to an embodiment of the present invention may include an electrode assembly 120 and a cover member 110 surrounding the electrode assembly 120, the electrode assembly 120 including first and second electrodes of an elongated shape and a separator or an electrolyte interposed between the first and second electrodes, each electrode including a current collector having a cross section of a circular, asymmetrical oval or polygonal shape perpendicular to the lengthwise direction thereof, and an electrode active material applied onto the surface of the current collector. The cover member 110 may have a preset pattern of continuous or discontinuous scratch grooves on the surface thereof.

The cable-type secondary battery of the present invention has a linear structure extending longitudinally and is flexible, so it is freely adaptable in shape. Here, the preset pattern is not limited to a specific pattern, and may include a repeated pattern and an irregular pattern without departing from the spirit and scope of the present invention. Also, the continuous scratch grooves may be defined as grooves that are not discontinuous and are at least three times longer than the diameter of the cable-type secondary battery of the present invention, and the discontinuous scratch grooves may be defined as grooves less than three times the diameter of the cable-type secondary battery of the present invention.

The electrode assembly 120 of the present invention is not limited to a specific type, and may be any type of electrode assembly including a cathode and an anode, and a separator or an electrolyte as an ion channel between the cathode and the anode. In this instance, the cathode may be made up of a cathode current collector and a cathode active material layer, and the anode may be made up of an anode current collector and an anode active material layer. Also, a plurality of cathodes and a plurality of anodes may contribute to the improvement of the battery performance.

The cover member 110 surrounding the electrode assembly 120 may have a preset pattern of scratch grooves on the surface thereof, to improve the flexibility of the cable-type secondary battery. When an external force is applied to the cable-type secondary battery, the scratch grooves of the cover member 110 may reduce the resistance to bending, so that the cover member 110 may be bent more easily. Also, even though the cover member 110 deforms due to an excessive external force, the scratch grooves may disperse the force concentrated on a specific area, thereby preventing the irreversible deformation.

Preferably, the scratch grooves have a depth of 10 to 30% to a thickness of the cover member 110. When the scratch grooves are too deep, the electrode assembly in the cover member may be exposed. When the scratch grooves are too shallow, a flexibility improvement effect may be insufficient. The cross section of the scratch grooves may be a square, a semicircle, a triangle, or any other various shapes depending on the manufacturing method.

The scratch grooves may be formed through post-processing, for example, by polishing with a sanding paper or by carving with a carving cutter having scratch groove patterns after the cover member 110 is formed, or may be formed by manufacturing the cover member 110 with scratch grooves through a mold having scratch groove patterns.

The cover member 110 of the present invention may be formed on the outer surface of the outer electrode assembly, and may serve as an insulator to protect the electrode from moisture in the air or from external impact. The cover member 110 may be formed from typical polymer resins, for example, PVC, HDPE, or epoxy resin.

Preferably, the current collector is made from stainless steel, aluminum, nickel, titanium, sintered carbon, or copper; stainless steel surface-treated with carbon, nickel, titanium, or silver; aluminum-cadmium alloys; non-conductive polymers surface-treated with a conductive material; or conductive polymers. The conductive material may include polyacetylene, polyaniline, polypyrrole, polythiophene, polysulfur nitride, indium thin oxide (ITO), copper, silver, palladium, and nickel. The conductive polymer may include polyacetylene, polyaniline, polypyrrole, polythiophene, and polysulfur nitride.

The anode active material may include, but is not limited to, natural graphite, artificial graphite, carbonaceous materials; lithium-containing titanium composite oxides (LTOs); metals (Me) such as Si, Sn, Li, Zn, Mg, Cd, Ce, Ni, or Fe; alloys of the metals (Me); oxides (MeOx) of the metals (Me); and composites of the metals (Me) and carbon. The cathode active material may include, but is not limited to, LiCoO₂, LiNiO₂, LiMn₂O₄, LiCoPO₄, LiFePO₄, LiNiMnCoO₂, and LiNi_{1-x-y-z}CoₓM1_{y}M2_{z}O₂ (M1 and M2 are each independently any one selected from the group consisting of Al, Ni, Co, Fe, Mn, V, Cr, Ti, W, Ta, Mg, and Mo, and x, y, and z are each independently an atomic fraction of each component in the oxide, where 0≦x<0.5, 0≦y<0.5, 0≦z<0.5, x+y+z≦1).

In the cable-type secondary battery of the present invention, the electrolyte layer surrounding the inner electrode serves as an ion channel, and is formed from a gel polymer electrolyte of PEO, PVdF, PMMA, PAN, or PVAc; or a solid polymer electrolyte of PEO, polypropylene oxide (PPO), polyethylene imine (PEI), polyethyl sulphide (PES), or polyvinyl acetate (PVAc).

In the cable-type secondary battery of the present invention, the electrolyte layer may further include a lithium salt. The lithium salt may include, but is not limited to, for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chlorine borane lithium, aliphatic lower lithium carbonate, and tetra-phenyl lithium borate.

The separator may be any one selected from the group consisting of a microporous polyethylene film, a microporous polypropylene film, or a multi-layered film of these films, and a polymer film for a polymer electrolyte of polyvinylidene fluoride, polyethylene oxide, polyacrylonitrile, or polyvinylidene fluoride-hexafluoropropylene copolymer. When a separator is used, the separator needs to be impregnated with an electrolyte for ion migration. The electrolyte may include a salt of A⁺B⁻ structure, wherein A⁺ represents an alkali metal cation such as Li⁺, Na⁺, K⁺ or their combinations, and B⁻ represents an anion such as PF₆⁻, BF₄⁻, Cl⁻, Br_, I⁻, ClO₄⁻, AsF₆⁻, CH₃CO₂⁻, CF₃SO₃⁻, N(CF₃SO₂)₂⁻, C(CF₂SO₂) ₃⁻ or combinations thereof. The salt may be dissolved or dissociated in an organic solvent selected from propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), gamma-butyrolactone (γ-butyrolactone), or mixtures thereof. However, the present invention is not limited in this regard. The electrolyte may be poured during a suitable step in the fabrication of a battery, based on the fabrication process and the desired properties of a final product. In other words, the electrolyte may be poured before the battery assembly or at the end of the battery assembly.

In this instance, the first and second electrodes of opposite polarity may each be an anode or a cathode. Preferably, the first electrode may be an anode and the second electrode may be a cathode.

Hereinafter, a method for fabricating the foregoing cable-type secondary battery is briefly described below.

The cable-type secondary battery 100 according to an embodiment of the present invention may include the electrode assembly 120 and the cover member 110 surrounding the electrode assembly 120, the electrode assembly 120 including an anode and a cathode of an elongated shape and a separator or an electrolyte layer interposed between the anode and the cathode, the anode or the cathode including a current collector having a cross section of a circular, asymmetrical oval or polygonal shape perpendicular to the lengthwise direction thereof and an electrode active material applied onto the surface of the current collector. The cover member 110 may have a preset pattern of scratch grooves on the surface thereof.

First, the wire-type linear anode current collector is prepared and surface-coated with the anode active material layer. In this instance, a typical coating process may be used, specifically an electroplating process or an anodic oxidation process. Also, extrusion-coating of an electrode slurry including an active material through an extruder may be used, however the present invention is not limited in this regard.

Subsequently, the anode active material layer is surface-coated with the electrolyte layer. In this instance, a process for forming the electrolyte layer is not specially limited, however extrusion-coating is advantageous in fabricating the cable-type linear secondary battery due to the characteristics of the battery.

Then, the electrolyte layer is surface-coated with the cathode active material layer. The same coating process as the anode active material layer may be applied to the cathode active material layer. Next, the pipe-type cathode current collector is formed on the outer surface of the cathode active material layer.

Finally, the cover member is formed on the outer surface of the pipe-type cathode current collector. The cover member is formed on the outmost surface and may act as an insulator to protect the electrode from moisture in the air or from external impact. The cover member may be made from typical polymer resins, for example, PVC, HDPE, or epoxy resin. In particular, the scratch grooves of the cover member according to the present invention may be formed through further processing after the cover member is formed, or may be formed using a mold having scratch groove patterns when forming the cover member.

Referring to FIGS. 2 and 3, the scratch grooves 111 and 112 may have a linear pattern having a predetermined angle to the lengthwise direction of the cover member. Here, the predetermined angle may include various angles inclined vertically or horizontally to the lengthwise direction of the cover member.

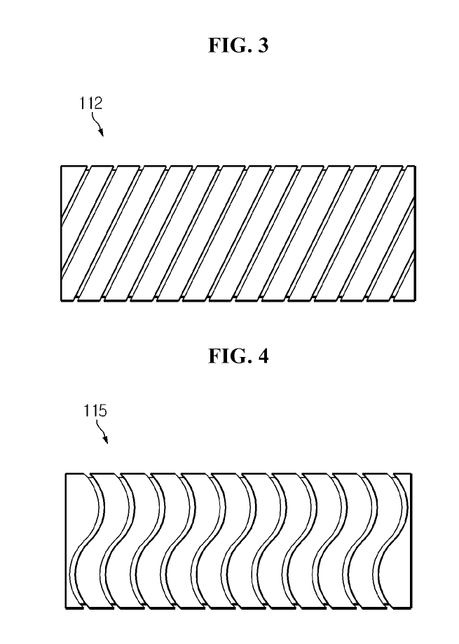

Referring to FIG. 4, the scratch grooves 115 may have a wavy pattern having a predetermined angle to the lengthwise direction of the cover member. Here, the predetermined angle may include various angles inclined vertically or horizontally to the lengthwise direction of the cover member.

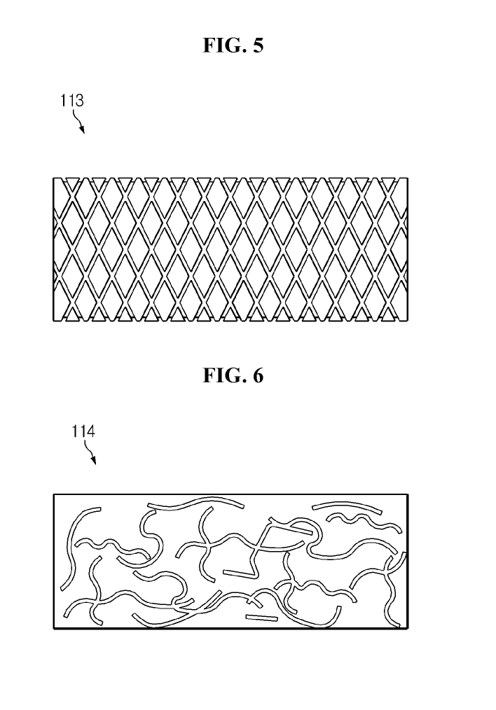

Referring to FIG. 5, the scratch grooves 113 may have a grid pattern. Referring to FIG. 6, the scratch grooves 114 may include a plurality of irregular scratch grooves.

1. A cable-type secondary battery comprising:
an electrode assembly; and
a cover member surrounding the electrode assembly,
the electrode assembly including:
first and second electrodes of an elongated shape, each electrode including a current collector having a cross section of a circular, asymmetrical oval or polygonal shape perpendicular to the lengthwise direction thereof, and an electrode active material applied onto the surface of the current collector, and
a separator or an electrolyte layer interposed between the first and second electrodes,
wherein the cover member has a preset pattern of continuous or discontinuous scratch grooves on the surface thereof.

2. The cable-type secondary battery according to claim 1,
wherein the scratch grooves have a depth of 10 to 30% to a thickness of the cover member.

3. The cable-type secondary battery according to claim 1,
wherein the scratch grooves have a linear pattern having a predetermined angle to the lengthwise direction of the cover member.

4. The cable-type secondary battery according to claim 1,
wherein the scratch grooves have a wavy pattern having a predetermined angle to the lengthwise direction of the cover member.

5. The cable-type secondary battery according to claim 1,
wherein the scratch grooves have a grid pattern.

6. The cable-type secondary battery according to claim 1,
wherein the scratch grooves include a plurality of irregular grooves.

7. The cable-type secondary battery according to claim 1,
wherein the first electrode is an anode and the second electrode is a cathode.

8. The cable-type secondary battery according to claim 1,
wherein the first active material includes an active material particle of any one selected from the group consisting of natural graphite, artificial graphite, or carbonaceous materials; lithium-containing titanium composite oxides (LTOs); metals (Me) including Si, Sn, Li, Zn, Mg, Cd, Ce, Ni, or Fe;
alloys of the metals (Me); oxides (MeOx) of the metals (Me); and composites of the metals (Me) and carbon, or mixtures thereof.

9. The cable-type secondary battery according to claim 1, wherein the second active material includes an active material particle of any one selected from the group consisting of LiCoO₂, LiNiO₂, LiMn₂O₄, LiCoPO₄, LiFePO₄, LiNiMnCoO₂, and LiNi_{1-x-y-z}CoₓM1_{y}M2_{z}O₂, or mixtures (M1 and M2 are each independently any one selected from the group consisting of Al, Ni, Co, Fe, Mn, V, Cr, Ti, W, Ta, Mg, and Mo, and x, y, and z are each independently an atomic fraction of each component in the oxide, where 0≦x<0.5, 0≦y<0.5, 0≦z<0.5, x+y+z≦1).

10. The cable-type secondary battery according to claim 1,
wherein the first current collector is made from stainless steel, aluminum, nickel, titanium, sintered carbon, or copper; stainless steel surface-treated with carbon, nickel, titanium, or silver; aluminum-cadmium alloys; non-conductive polymer surface-treated with a conductive material; or conductive polymers.

11. The cable-type secondary battery according to claim 1,
wherein the second current collector is made from stainless steel, aluminum, nickel, titanium, sintered carbon, or copper; stainless steel surface-treated with carbon, nickel, titanium, or silver; aluminum-cadmium alloys; non-conductive polymer surface-treated with a conductive material; or conductive polymers.

12. The cable-type secondary battery according to claim 10,
wherein the conductive material is any one selected from the group consisting of polyacetylene, polyaniline, polypyrrole, polythiophene, polysulfur nitride, indium thin oxide (ITO), copper, silver, palladium, and nickel, or mixtures thereof.

13. The cable-type secondary battery according to claim 10,
wherein the conductive polymer is any one selected from the group consisting of polyacetylene, polyaniline, polypyrrole, polythiophene, and polysulfur nitride, or mixtures thereof.

14. The cable-type secondary battery according to claim 1,
wherein the electrolyte layer is formed from an electrolyte selected from the group consisting of a gel polymer electrolyte of PEO, PVdF, PMMA, PAN, or PVAc; and a solid polymer electrolyte of PEO, polypropylene oxide (PPO), polyethylene imine (PEI), polyethyl sulphide (PES), or polyvinylacetate (PVAc).

15. The cable-type secondary battery according to claim 1,
wherein the electrolyte layer further includes a lithium salt.

16. The cable-type secondary battery according to claim 15,
wherein the lithium salt is any one selected from the group consisting of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chlorine borane lithium, aliphatic lower lithium carbonate, and tetra-phenyl lithium borate, or mixtures thereof.

17. The cable-type secondary battery according to claim 1,
wherein the separator is any one selected from the group consisting of a microporous polyethylene film, a microporous polypropylene film, or a multi-layered film of these films, and a polymer film for a polymer electrolyte of polyvinylidene fluoride, polyethylene oxide, polyacrylonitrile, or polyvinylidene fluoride-hexafluoropropylene copolymer.

18. The cable-type secondary battery according to claim 11,
wherein the conductive material is any one selected from the group consisting of polyacetylene, polyaniline, polypyrrole, polythiophene, polysulfur nitride, indium thin oxide (ITO), copper, silver, palladium, and nickel, or mixtures thereof.

19. The cable-type secondary battery according to claim 11,
wherein the conductive polymer is any one selected from the group consisting of polyacetylene, polyaniline, polypyrrole, polythiophene, and polysulfur nitride, or mixtures thereof.
